(19) United States
(12) Patent Application Publication
(10) Pub. No.: US 2025/0364900 A1
(43) Pub. Date: Nov. 27, 2025

(54) RECTIFIER CIRCUIT

(71) Applicant: ROHM CO., LTD., Kyoto-shi (JP)

(72) Inventors: Shuichiro MOTOORI, Kyoto-shi (JP); Akihiro KAWANO, Kyoto-shi (JP); Toshiyuki ZAITSU, Kyoto-shi (JP)

(21) Appl. No.: 19/219,122

(22) Filed: May 27, 2025

(30) Foreign Application Priority Data
May 27, 2024 (JP) 2024-085806

(51) Int. Cl. H02M 1/12; H02M 1/00; H02M 3/335; H02M 7/217

(52) U.S. Cl. CPC H02M 1/126; H02M 1/0048; H02M 3/33571; H02M 7/217

(57) ABSTRACT

A first input terminal IN and a second input terminal IN are connected to an AC power supply. A half-wave rectifier charges a smoothing capacitor in a half cycle in which an AC voltage is positive and generates a half-wave rectified voltage in the smoothing capacitor. The half-wave rectifier is configured to be able to switch conduction and cutoff of a charging path to the smoothing capacitor in the half cycle. A controller controls the conduction and cutoff of the charging path according to a voltage across the smoothing capacitor.

### CROSS REFERENCE TO RELATED APPLICATIONS

The present invention claims priority under 35 U.S.C. § 119 to Japanese Application No. 2024-085806, filed on May 27, 2024, the entire contents of which being incorporated herein by reference.

### BACKGROUND

### 1. Technical Field

The present disclosure relates to a rectifier circuit and an AC/DC converter.

### 2. Description of Related Art

An AC (Alternating Current)/DC (Direct Current) converter is used to supply power from a commercial AC power supply to an electronic device. The AC/DC converter includes a rectifier circuit that rectifies an AC voltage, and a DC/DC converter that converts an output voltage of the rectifier circuit into a voltage level suitable for a load.

In AC/DC converters of 75 W or less that do not require power factor correction (PFC), it is general to use an AC rectifier circuit in which a diode bridge and an electrolytic capacitor are combined. In this configuration, a voltage approximately √2 times an AC input voltage is generated in the electrolytic capacitor. Therefore, it is necessary to select, for example, a component having a high withstand voltage of 400 V as the electrolytic capacitor. This electrolytic capacitor has been an obstacle to downsizing and cost reduction of the AC/DC converter.

### SUMMARY

### Overview

The present disclosure has been made in view of such a situation, and one purpose thereof is to downsize an AC/DC converter.

One embodiment of the present disclosure relates to a rectifier circuit. The rectifier circuit includes: a first input terminal and a second input terminal structured to receive an AC voltage; a smoothing capacitor; a half-wave rectifier connected to the first input terminal and the second input terminal, and structured to charge the smoothing capacitor in a half cycle of the AC voltage, generate a half-wave rectified voltage in the smoothing capacitor, and switch conduction and cutoff of a charging path to the smoothing capacitor in the half cycle; and a controller structured to control the conduction and cutoff of the charging path according to a voltage across the smoothing capacitor.

Note that arbitrary combinations of the above components and conversions of components and an expression between a method, an apparatus, a system, and the like are also effective as embodiments of the present disclosure. Furthermore, since the description of this item (SUMMARY OF THE INVENTION) does not describe all essential features of the present disclosure, subcombinations of these features described may also be included in the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram of an AC/DC converter according to a first embodiment;

FIG. 2 is a waveform diagram for explaining the operation of the AC/DC converter of FIG. 1;

FIG. 3 is a circuit diagram illustrating a modification of the AC/DC converter of FIG. 1;

FIG. 4 is a circuit diagram of an AC/DC converter according to a second embodiment; and

FIG. 5 is a waveform diagram for explaining the operation of the AC/DC converter of FIG. 4.

### DETAILED DESCRIPTION

The invention will now be described by reference to the preferred embodiments. This does not intend to limit the scope of the present invention, but to exemplify the invention.

### Outline of Embodiments

An outline of some exemplary embodiments of the present disclosure will be described. This outline describes some concepts of one or more embodiments in a simplified manner for the purpose of basic understanding of the embodiments as a prelude to the detailed description below and does not limit the breadth of the invention or disclosure. This outline is not a comprehensive outline of all possible embodiments and is not intended to identify important elements of all embodiments or delineate the scope of some or all embodiments. For convenience, “one embodiment” may be used to refer to one embodiment (example or modification) or a plurality of embodiments (examples or modifications) disclosed in the present specification.

A rectifier circuit according to an embodiment includes: a first input terminal and a second input terminal connected to an AC power supply; a smoothing capacitor; a half-wave rectifier connected to the first input terminal and the second input terminal, and structured to charge the smoothing capacitor in a half cycle of an AC voltage, generate a half-wave rectified voltage in the smoothing capacitor, and switch conduction and cutoff of a charging path to the smoothing capacitor in the half cycle; and a controller structured to control the conduction and cutoff of the charging path according to a voltage across the smoothing capacitor.

According to this configuration, by clamping a voltage across the smoothing capacitor, a withstand voltage required for the smoothing capacitor can be reduced. As a result, a small electrolytic capacitor can be used as the smoothing capacitor, and an apparatus can be reduced in size and cost.

In an embodiment, the half-wave rectifier may include a clamp transistor that is a one-way switch connected between the first input terminal and a first end of the smoothing capacitor, and a rectifier diode connected between the second input terminal and a second end of the smoothing capacitor. The controller may control the clamp transistor. In addition, the clamp transistor which is the one-way switch is incorporated in a current loop including the rectifier diode and the smoothing capacitor, and a current conduction direction in an off state of the one-way switch is made opposite to that of the rectifier diode, so that the conduction and cutoff of the charging path to the smoothing capacitor can be switched. In this configuration, a circuit area can be reduced as compared with a case where a diode bridge circuit and a voltage clamp circuit are separately configured.

In an embodiment, the half-wave rectifier may include a clamp transistor that is a bidirectional switch connected between one of the first input terminal and the second input terminal and a first end of the smoothing capacitor. The controller may control the clamp transistor.

According to this configuration, since a rectifier element of the half-wave rectifier includes a transistor, on-resistance can be reduced as compared with a case where the rectifier element includes a diode, and efficiency can be improved. The rectifier element also functions as a switch for switching the conduction and cutoff of the charging path of the smoothing capacitor, so that the circuit area can be reduced. In addition, the circuit area can be reduced as compared with a case where a diode bridge circuit and a voltage clamp circuit are separately configured.

In an embodiment, the first end of the smoothing capacitor may be connected to an input terminal of a DC/DC converter at a subsequent stage, and the second end of the smoothing capacitor may be connected to a ground line of the DC/DC converter.

In an embodiment, the first end of the smoothing capacitor may be connected to a ground line of a DC/DC converter at a subsequent stage, and the second end of the smoothing capacitor may be connected to an input terminal of the DC/DC converter.

An AC/DC converter according to an embodiment may include any one of the rectifier circuits described above; and a DC/DC converter connected to the rectifier circuit.

### EMBODIMENTS

Hereinafter, preferred embodiments will be described with reference to the drawings. The same or equivalent components, members, and processes illustrated in the drawings will be denoted by the same reference numerals, and repeated description will be omitted as appropriate. Further, the embodiments do not limit the disclosure and the invention, but are exemplary, and all features and combinations thereof described in the embodiments are not necessarily essential to the disclosure and the invention.

In the present specification, a “state where a member A is connected to a member B” includes not only a case where the member A and the member B are directly connected physically but also a case where the member A and the member B are indirectly connected via another member that does not substantially affect an electrical connection state or does not impair a function and an effect provided by connection.

Similarly, a “state where a member C is provided between the members A and B” includes not only a case where the members A and C or the members B and C are directly connected but also a case where the members A and C or the members B and C are indirectly connected via another member that does not substantially affect an electrical connection state or does not impair a function and an effect provided by connection.

### First Embodiment

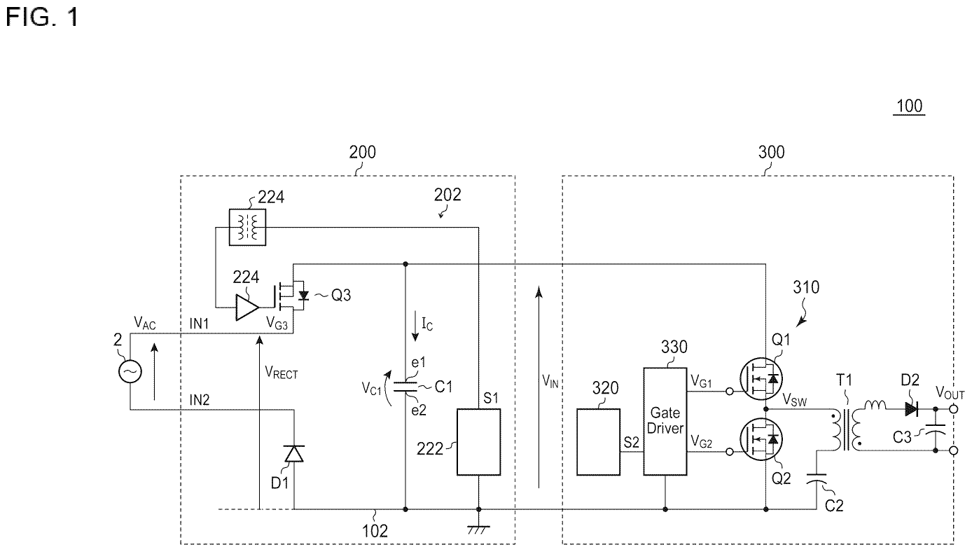

FIG. 1 is a circuit diagram of an AC/DC converter 100 according to a first embodiment. The AC/DC converter 100 receives an AC voltage V_{AC} from an AC power supply 2 and converts the AC voltage V_{AC} into a DC voltage V_{OUT}. The AC voltage V_{AC} alternately repeats a positive half cycle Tp and a negative half cycle Tn.

The AC/DC converter 100 includes a rectifier circuit 200 and a DC/DC converter 300.

The rectifier circuit 200 half-wave rectifies and smooths the AC voltage V_{AC} to convert the AC voltage into a DC input voltage V_{IN}. The DC/DC converter 300 converts the DC input voltage V_{IN} into a DC output voltage V_{OUT}.

The rectifier circuit 200 includes a half-wave rectifier 202 and a controller 222.

The first input terminal IN1 and the second input terminal IN2 of the rectifier circuit 200 are connected to the AC power supply 2 and receive the AC voltage V_{AC}.

The half-wave rectifier 202 is connected to the first input terminal IN1 and the second input terminal IN2. The half-wave rectifier 202 supplies a charging current I_{C} to a smoothing capacitor C1 in a half cycle Tp in which the AC voltage V_{AC} is positive, and generates a half-wave rectified voltage V_{C1} in the smoothing capacitor C1.

The half-wave rectifier 202 is configured to be able to switch conduction and cutoff of a charging path to the smoothing capacitor C1 in the half cycle Tp in which the AC voltage V_{AC} is positive.

The controller 222 controls conduction and cutoff of the charging path according to a voltage V_{C1} across the smoothing capacitor C1.

In the present embodiment, the half-wave rectifier 202 includes a rectifier diode D1, a clamp transistor Q3, and a gate driver 224.

The rectifier diode D1 is connected between the second input terminal IN2 and a second end e2 of the smoothing capacitor C1 in a direction in which a cathode is on the second input terminal IN2 side. The clamp transistor Q3 is connected between the first input terminal IN1 and a first end e1 of the smoothing capacitor C1. The clamp transistor Q3 is a one-way switch that cuts off a current in one direction and a conduction direction of the rectifier diode D1 in an off state. The clamp transistor Q3 can include an N-channel MOSFET in which a drain and a back gate are connected.

The first end e1 of the smoothing capacitor C1 is connected to an input terminal of the DC/DC converter 300, and the second end e2 of the smoothing capacitor C1 is connected to a ground line 102 common to the rectifier circuit 200 and the DC/DC converter 300. That is, the voltage V_{C1} across the smoothing capacitor C1 is supplied as the input voltage V_{IN} to the DC/DC converter 300 at a subsequent stage.

The rectifier circuit 200 has a voltage clamping function. The controller 222 controls on and off of the clamp transistor Q3 according to the voltage V_{C1} across the smoothing capacitor C1.

The controller 222 generates a control signal S1 instructing on and off of the clamp transistor Q3 based on the voltage (referred to as a capacitor voltage) V_{C1} of the smoothing capacitor C1. A method for generating the control signal S1 by the controller 222 is not particularly limited, and the control signal S1 may be generated such that the voltage V_{C1} across the smoothing capacitor C1 does not exceed a certain threshold.

For example, when the AC voltage V_{AC}becomes lower than the capacitor voltage Vc1, the controller 222 changes the control signal S1 to a level corresponding to on of the clamp transistor Q3. When the capacitor voltage V_{C1} exceeds the threshold voltage V_{TH}, the control signal S1 is changed to a level corresponding to off of the clamp transistor Q3.

The gate driver 224 controls a gate voltage V_{G3} of the clamp transistor Q3 based on the control signal S1. Since the source of the clamp transistor Q3 is a floating node, the gate driver 224 may be configured as an isolated gate drive circuit.

The above is the configuration of the rectifier circuit 200. Next, the DC/DC converter 300 will be described.

The topology of the DC/DC converter 300 is not particularly limited, and an isolated converter or a non-isolated converter can be used. For example, the DC/DC converter 300 may be an asymmetrical half-bridge (AHB) converter.

The DC/DC converter 300 includes a half-bridge circuit 310, a transformer T1, a resonance capacitor C2, a diode D2, an output capacitor C3, a controller 320, and a gate driver 330. The half-bridge circuit 310 includes a high-side transistor Q1 and a low-side transistor Q2. The controller 320 generates a control signal S2 that is a pulse signal such that the output voltage V_{OUT} approaches a target level. A method for generating the control signal S2 is not particularly limited, and pulse width modulation, pulse frequency modulation, or the like can be used. The gate driver 330 generates gate voltages V_{G1} and V_{G2} of the high-side transistor Q1 and the low-side transistor Q2 according to the control signal S2.

The controller 222, the gate driver 224, the controller 320, and the gate driver 330 may be integrated on one semiconductor substrate to form a control integrated circuit (IC). The controller 222, the controller 320, and the gate driver 330 are connected to the common ground line 102 with the rectifier circuit 200 and operate based on a common reference voltage (ground voltage).

The configuration of the AC/DC converter 100 has been described above. Subsequently, the operation will be described.

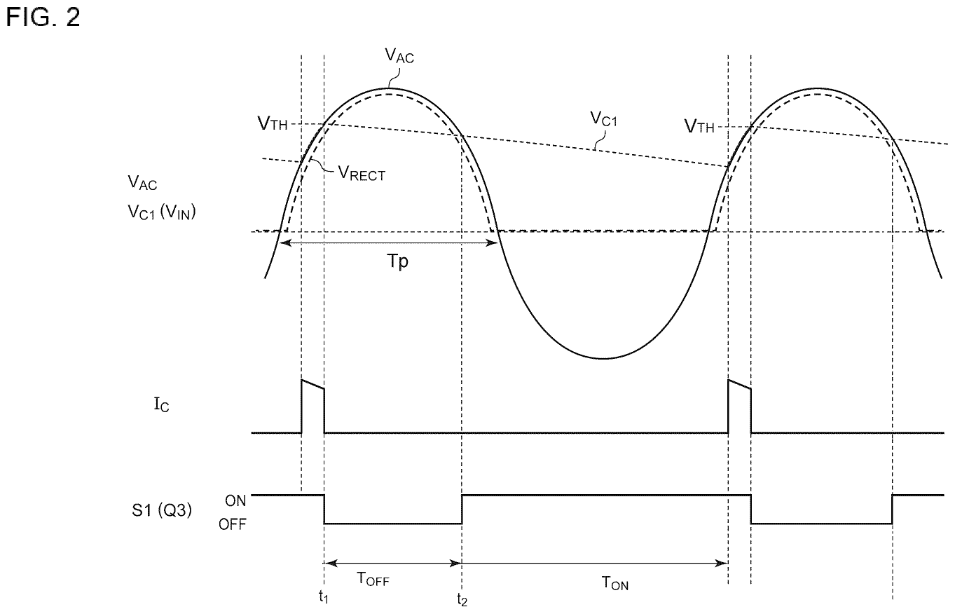

FIG. 2 is a waveform diagram for explaining the operation of the AC/DC converter 100 of FIG. 1. FIG. 2 illustrates, in order from the top, the AC voltage V_{AC}, the rectified voltage V_{RECT}, the voltage V_{C1} (input voltage V_{IN}) of the smoothing capacitor C1, the charging current I_{C} flowing through the smoothing capacitor C1, and the control signal S1 instructing on and off of the clamp transistor Q3.

The rectified voltage V_{RECT} is a virtual voltage obtained by half-wave rectifying the AC voltage V_{AC}. During a period T_{ON} where the control signal S1 is high, that is, the clamp transistor Q3 is turned on, when V_{RECT}>V_{C1} is satisfied, the smoothing capacitor C1 is charged, and the voltage V_{C1} of the smoothing capacitor C1 increases following the rectified voltage V_{RECT}.

When the rectified voltage V_{RECT} (AC voltage V_{AC}) reaches the threshold voltage V_{TH} at time t1, the control signal S1 becomes low, and the clamp transistor Q3 is turned off. During a period T_{OFF} where the clamp transistor Q3 is turned off, the smoothing capacitor C1 is discharged by an input current of the DC/DC converter 300 and the voltage thereof decreases with time.

When the AC voltage V_{AC}becomes lower than the voltage V_{C1} of the smoothing capacitor C1 at time t₂, the control signal S1 becomes high, and the clamp transistor Q3 is turned on. The AC/DC converter 100 repeats the above operation.

The above is the operation of the AC/DC converter 100. In the AC/DC converter 100, in the half cycle Tp in which the AC voltage V_{AC}is positive, during a period of V_{AC}>V_{TH} (V_{RECT}>V_{TH}), the clamp transistor Q3 is turned off, and the voltage V_{C1} across the smoothing capacitor C1 is clamped, so that the withstand voltage required for the smoothing capacitor C1 can be lowered. As a result, a small electrolytic capacitor can be used as the smoothing capacitor C1, and an apparatus can be reduced in size and cost.

In addition, by incorporating the clamp transistor Q3, which is a one-way switch, in the current loop including the rectifier diode D1 and the smoothing capacitor C1 and using the clamp transistor Q3 to clamp the voltage of the smoothing capacitor C1, the circuit area can be reduced as compared with a case where the diode bridge circuit and the voltage clamp circuit are separately configured.

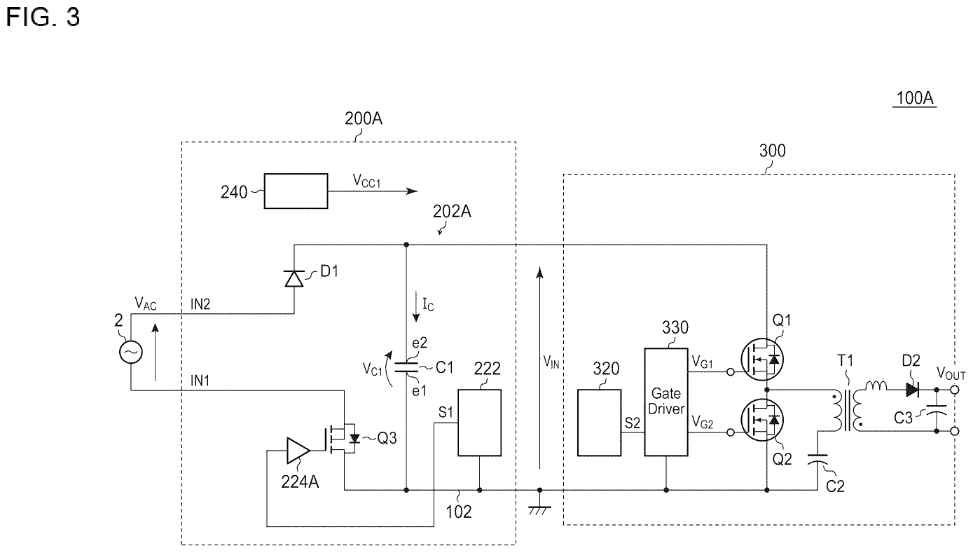

FIG. 3 is a circuit diagram illustrating a modification of the AC/DC converter 100 of FIG. 1. A DC/DC converter 300 at a subsequent stage is similar to that in FIG. 1.

Differences between a rectifier circuit 200A of FIG. 3 and the rectifier circuit 200 of FIG. 1 will be described. In FIG. 3, the positions of the clamp transistor Q3 and the rectifier diode D1 are switched. The first end e1 of the smoothing capacitor C1 is connected to the ground line 102 of the DC/DC converter at the subsequent stage, and the second end e2 of the smoothing capacitor C1 is connected to the input terminal of the DC/DC converter 300.

In this configuration, the source of the clamp transistor Q3 is connected to the ground line 102, and the potential is fixed. Therefore, a gate driver 224A that drives the clamp transistor Q3 can have a simple configuration of a non-isolated type.

When an AC/DC converter 100A is activated, the clamp transistor Q3 is turned off, the smoothing capacitor C1 cannot be charged by the path including the clamp transistor Q3 and the rectifier diode D1, and a power supply voltage V_{CC} necessary for the operation of the rectifier circuit 200A and the DC/DC converter 300 cannot be generated. Therefore, at the time of activation, a voltage circuit 240 that generates a power supply voltage V_{CC1} for activating the circuit based on the input voltage V_{AC} is provided.

### Second Embodiment

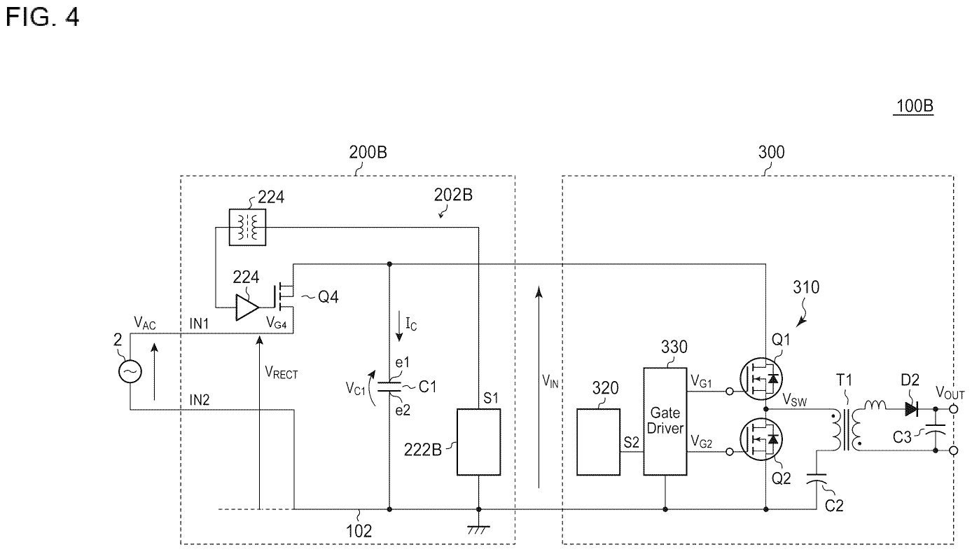

FIG. 4 is a circuit diagram of an AC/DC converter 100B according to a second embodiment. A half-wave rectifier 202B includes a smoothing capacitor C1 and a clamp transistor Q4. The clamp transistor Q4 includes a bidirectional switch and is configured to cut off a current in both directions in an off state. The clamp transistor Q4 also functions as a rectifier diode D1 and a clamp transistor Q3 in the first embodiment.

A controller 222B generates a control signal S1 such that the clamp transistor Q4 is turned off in a half cycle Tn in which an AC voltage V_{AC} is negative. As a result, the clamp transistor Q4 has a function as a rectifier diode. In addition, the controller 222B controls the clamp transistor Q4 such that a voltage V_{C1} of the smoothing capacitor C1 does not exceed a threshold V_{TH} in a half cycle Tp in which the AC voltage V_{AC} is positive.

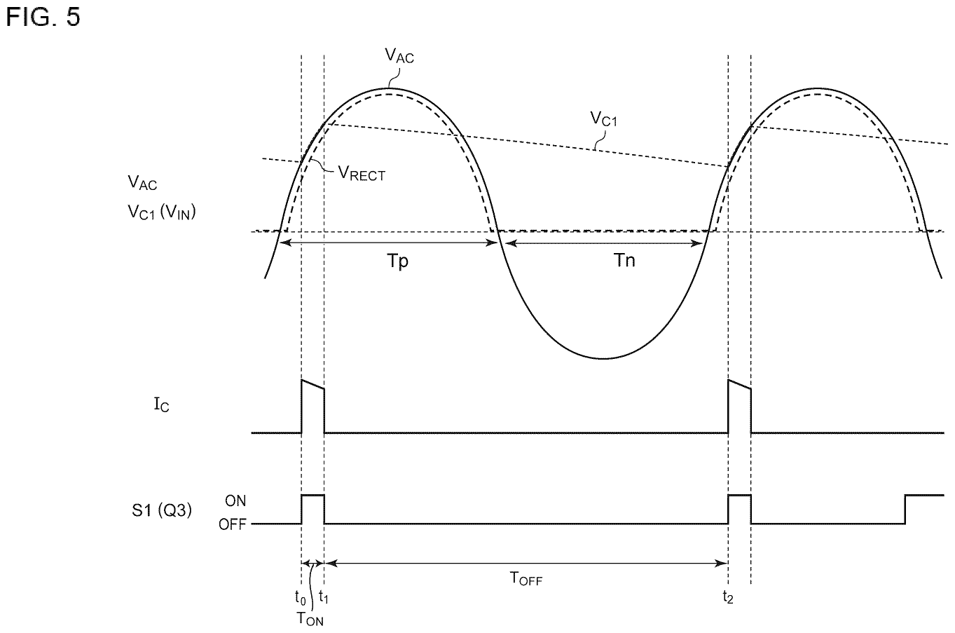

FIG. 5 is a waveform diagram for explaining the operation of the AC/DC converter 100B of FIG. 4. FIG. 5 illustrates, in order from the top, the AC voltage V_{AC}, a rectified voltage V_{RECT}, the voltage V_{C1} (input voltage V_{IN}) of the smoothing capacitor C1, a charging current I_{C} flowing through the smoothing capacitor C1, and the control signal S1 instructing on and off of the clamp transistor Q4.

The rectified voltage V_{RECT} is a virtual voltage obtained by half-wave rectifying the AC voltage V_{AC}. In the half cycle Tn in which the AC voltage V_{AC} is negative, the clamp transistor Q4 is turned off, and half-wave rectification is realized. That is, the clamp transistor Q4 functions as a synchronous rectification switch.

When the AC voltage V_{AC} (rectified voltage V_{AC}) exceeds the capacitor voltage V_{C1} at time t₀, the control signal S1 becomes high, and the clamp transistor Q4 is turned on. During a period T_{ON} where the clamp transistor Q4 is turned on, the smoothing capacitor C1 is charged, and the voltage V_{C1} of the smoothing capacitor C1 increases following the rectified voltage V_{RECT}.

When the rectified voltage V_{RECT} (AC voltage V_{AC}) reaches the threshold voltage V_{TH} at time t1, the control signal S1 becomes low and the clamp transistor Q4 is turned off. During a period T_{OFF} where the clamp transistor Q4 is turned off, the smoothing capacitor C1 is discharged by the input current of the DC/DC converter 300 and decreases with time.

The AC/DC converter 100B repeats the above operation.

According to the rectifier circuit 200B according to the second embodiment, since a rectifier element of the half-wave rectifier 202B includes a transistor, on-resistance can be reduced as compared with a case where the rectifier element includes a diode, and efficiency can be improved. The rectifier element also functions as a switch for switching the conduction and cutoff of the charging path of the smoothing capacitor, so that the circuit area can be reduced. In addition, the circuit area can be reduced as compared with a case where a diode bridge circuit and a voltage clamp circuit are separately configured.

Although the embodiment according to the present disclosure has been described using specific terms, this description is merely an example for assisting understanding and does not limit the present disclosure or the claims, and the scope of the present disclosure is defined by the claims. Furthermore, not only the embodiment but also embodiments, examples, and modifications not described herein are included in the scope of the present disclosure.

The circuit topology of the DC/DC converter 300 is not particularly limited, and one suitable for the power and application of the AC/DC converter 100 can be selected. For example, the DC/DC converter 300 may be a flyback converter, a forward converter, or the like, or may be a full-bridge converter. In addition, the DC/DC converter 300 can use a non-isolated converter such as a step-down converter (Buck converter), a step-up converter (Boost converter), and a step-up/down converter (Buck-Boost converter) in an application that does not require insulation.

### SUPPLEMENTARY NOTE

The technology disclosed in the present specification can be understood as follows in one aspect.

### Item 1

A rectifier circuit including:
a first input terminal and a second input terminal structured to receive an AC voltage; a smoothing capacitor;
a half-wave rectifier connected to the first input terminal and the second input terminal, and structured to charge the smoothing capacitor in a half cycle of the AC voltage, generate a half-wave rectified voltage in the smoothing capacitor, and switch conduction and cutoff of a charging path to the smoothing capacitor in the half cycle; and
a controller structured to control the conduction and cutoff of the charging path according to a voltage across the smoothing capacitor.

### Item 2

The rectifier circuit according to Item 1, wherein
the half-wave rectifier includes a clamp transistor that is a one-way switch connected between the first input terminal and a first end of the smoothing capacitor, and a rectifier diode connected between the second input terminal and a second end of the smoothing capacitor, and
the controller controls the clamp transistor.

### Item 3

The rectifier circuit according to Item 1, wherein
the half-wave rectifier includes a clamp transistor that is a bidirectional switch connected between one of the first input terminal and the second input terminal and a first end of the smoothing capacitor, and
the controller controls the clamp transistor.

### Item 4

The rectifier circuit according to any one of Items 1 to 3, wherein
a first end of the smoothing capacitor is connected to a ground line of a DC/DC converter at a subsequent stage, and a second end of the smoothing capacitor is connected to an input terminal of the DC/DC converter.

### Item 5

The rectifier circuit according to any one of Items 1 to 3, wherein

a first end of the smoothing capacitor is connected to a ground line of a DC/DC converter at a subsequent stage, and a second end of the smoothing capacitor is connected to an input terminal of the DC/DC converter.

### Item 6

An AC/DC converter including:
the rectifier circuit according to any one of Items 1 to 5; and
a DC/DC converter connected to the rectifier circuit.

What is claimed is:

1. A rectifier circuit comprising:
a first input terminal and a second input terminal structured to receive an AC voltage;
a smoothing capacitor;
a half-wave rectifier connected to the first input terminal and the second input terminal, and structured to charge the smoothing capacitor in a half cycle of the AC voltage, generate a half-wave rectified voltage in the smoothing capacitor, and switch conduction and cutoff of a charging path to the smoothing capacitor in the half cycle; and
a controller structured to control the conduction and cutoff of the charging path according to a voltage across the smoothing capacitor.

2. The rectifier circuit according to claim 1, wherein the half-wave rectifier includes a clamp transistor that is a one-way switch connected between the first input terminal and a first end of the smoothing capacitor, and a rectifier diode connected between the second input terminal and a second end of the smoothing capacitor, and the controller controls the clamp transistor.

3. The rectifier circuit according to claim 1, wherein the half-wave rectifier includes a clamp transistor that is a bidirectional switch connected between one of the first input terminal and the second input terminal and a first end of the smoothing capacitor, and the controller controls the clamp transistor.

4. The rectifier circuit according to claim 1, wherein the first end of the smoothing capacitor is connected to an input terminal of a DC/DC converter at a subsequent stage, and the second end of the smoothing capacitor is connected to a ground line of the DC/DC converter.

5. The rectifier circuit according to claim 1, wherein the first end of the smoothing capacitor is connected to a ground line of a DC/DC converter at a subsequent stage, and the second end of the smoothing capacitor is connected to an input terminal of the DC/DC converter.

6. An AC/DC converter comprising:
the rectifier circuit according to claim 1; and
a DC/DC converter connected to the rectifier circuit.
